(19) United States
(12) Patent Application Publication
(10) Pub. No.: US 2022/0352580 A1
(43) Pub. Date: Nov. 3, 2022

(54) RECHARGEABLE BATTERY

(71) Applicant: Samsung SDI Co., Ltd., Yongin-si, Gyeonggi-do (KR)

(72) Inventors: Jong-Ha LEE, Yongin-si (KR); Youmee KIM, Yongin-si (KR); Byoungmin CHUN, Yongin-si (KR)

(21) Appl. No.: 17/633,543

(22) PCT Filed: Jul. 28, 2020
(86) PCT No.: PCT/KR2020/009945

§ 371 Date: Feb. 7, 2022

(30) Foreign Application Priority Data
Aug. 19, 2019 (KR) 10-2019-0101310

(51) Int. Cl. H01M 50/148; H01M 50/109; H01M 50/153; H01M 50/181; H01M 50/46; H01M 50/566; H01M 50/188

(52) U.S. Cl. CPC H01M 50/154; H01M 50/109; H01M 50/153; H01M 50/181; H01M 50/46; H01M 50/566; H01M 50/188

(57) ABSTRACT

A rechargeable battery according to an embodiment of the present invention includes: an electrode assembly in which a separator is disposed between a first electrode and a second electrode; a case having an opening on one side and accommodating the electrode assembly; and a cap assembly coupled to the opening so as to seal the case. The cap assembly includes: a cap plate coupled to the opening and provided with a terminal hole; a terminal plate disposed inside the terminal hole; and an insulating material, and also includes a sealing portion which covers a circumferential portion on the terminal hole side of the cap plate and a circumferential portion of the terminal plate so as to form a seal between the cap plate and the terminal plate.

### TECHNICAL FIELD

The present invention relates to a rechargeable battery. More particularly, the present invention relates to a miniature secondary battery.

### BACKGROUND ART

Unlike a primary battery that cannot be recharged, a rechargeable battery is a battery that can be charged and discharged. A low-capacity rechargeable battery is used for portable small electronic devices such as mobile phones, laptop computers, and camcorders, and a large-capacity battery is widely used as a power source for driving motors such as for hybrid vehicles.

As a representative rechargeable battery, a nickel-cadmium (Ni—Cd) battery, a nickel-metal hydride (Ni-MH) battery, a lithium (Li) battery, and a lithium ion (Li-ion) battery may be included. In particular, lithium ion rechargeable batteries have an operation voltage about three times higher than nickel-cadmium batteries or nickel-metal hydride batteries, which are widely used as power sources for portable electronic equipment. In addition, it is widely used in terms of high energy density per unit weight.

In particular, recently, as the demand for wearable devices such as headphones, earphones, smartwatches, and body-attached medical devices using Bluetooth increases, the need for a rechargeable battery having high energy density with ultra-small size is increasing.

As an example, the ultra-small rechargeable battery includes a coin-type battery (coin cell) or a button-type battery (button cell). In general, a coin-type cell (coin cell) or a button-type battery (button cell) has a low height, and is coupled through crimping between a cell cup, which is the half of the housing, and a cell top. Accordingly, there is a problem in that the battery capacity is reduced.

In addition, when a separate electrode terminal is provided in the housing, a thickness of a portion where the electrode terminal is installed may increase and the battery capacity may be reduced, and difficulty in welding between the electrode tab of the electrode assembly and the electrode terminal may occur.

### DISCLOSURE

### Technical Problem

One aspect of the present invention is to increase battery capacity by reducing a thickness of a portion where an electrode terminal is installed, and to provide a rechargeable battery that facilitates a connection between an electrode tab and a electrode terminal of an electrode assembly.

### Technical Solution

A rechargeable battery according to an embodiment of the present invention includes: an electrode assembly in which a separator is disposed between a first electrode and a second electrode; a case including an opening at one side, and accommodating the electrode assembly; and a cap assembly that is coupled to the opening to close and seal the case, wherein the cap assembly includes: a cap plate coupled to the opening and including a terminal hole; a terminal plate disposed in the terminal hole; and a sealing portion that is formed of an insulating material, and seals between the cap plate and the terminal plate by covering a circumferential portion of the terminal hole side of the cap plate and a circumferential portion of the terminal plate.

The cap plate, the terminal plate, and the sealing portion may be integrally formed by insert injection.

One side of the cap plate and one side of the terminal plate may be arranged on the same plane.

A top surface and a bottom surface of the sealing portion may be flat, and the cap plate and the terminal plate may be disposed between the top and bottom surfaces of the sealing portion.

The sealing portion may be annular, and, a circumferential portion of the terminal hole side of the cap plate and a circumferential portion of the terminal plate may be respectively inserted into an outer circumferential portion and an inner circumferential portion of the sealing portion.

A thickness of the terminal plate may be smaller than a thickness of the cap plate.

The rechargeable battery may further include a first electrode tab that electrically connects the first electrode to the terminal plate; and a second electrode tab that electrically connects the second electrode to the case and the cap plate.

In the electrode assembly, the first electrode, the second electrode, and the separator may be wound around a center pin, and the center pin may be arranged in a vertical direction on a bottom surface of the case.

The first electrode tab may be extended upwardly of the electrode assembly and welded to an inner surface of the terminal plate, and the second electrode tab may extend downwardly of the electrode assembly and welded to an inner surface of the case.

The rechargeable battery may further include: a first insulation member that is disposed between the first electrode tab and a top surface of the electrode assembly; and a second insulation member that is disposed between the second electrode tab and a bottom surface of the electrode assembly.

The rechargeable battery may further include a third insulation member that is disposed between the first electrode tab and the cap plate.

At least one of an end of the circumferential portion of the terminal hole side of the cap plate and an end of the circumferential portion of the terminal plate may be bent.

The end of the circumferential portion of the terminal hole side of the cap plate and the end of the circumferential portion of the terminal plate may be provided with bending portions that are bent in a direction perpendicular to an extension direction of the terminal plate.

A plurality of penetration holes may be formed in at least one of the circumferential portion of the terminal hole side of the cap plate and the circumferential portion of the terminal plate.

The sealing portion may be inserted into the plurality of penetration holes.

A plurality of exposed grooves extending in a radiation direction in an inner circumferential portion of the sealing portion may be formed on a bottom surface of the sealing portion.

A plurality of exposed holes disposed at predetermined angle intervals along a circumferential direction may be formed on a bottom surface of the sealing portion.

The case may be cylindrical, and the cap plate may be welded to the opening of the case.

The rechargeable battery may have a height-to-diameter ratio of 1 or less.

### Advantageous Effects

According to the embodiments of the present invention, the thickness of the cap assembly can be reduced and the battery capacity can be increased by installing the terminal plate with a sealing material in the terminal hole of the cap plate. In addition, the welding operation between the electrode tab and the terminal plate of the electrode assembly can be facilitated.

### DESCRIPTION OF THE DRAWINGS

FIG. 1 is a perspective view of a rechargeable battery according to a first embodiment of the present invention.

FIG. 2 is an exploded perspective view of the rechargeable battery according to the first embodiment of the present invention.

FIG. 3 is a cross-sectional view of FIG. 2, taken along the line III-III.

FIG. 4 is an enlarged view of the portion IV of FIG. 3.

FIG. 5 to FIG. 7 show a cap assembly of the rechargeable battery according to the first embodiment of the present invention.

FIG. 8 is a cross-sectional view of a rechargeable battery according to a second embodiment of the present invention.

FIG. 9 is an enlarged view of the portion IX of FIG. 8.

FIG. 10 to FIG. 12 show a cap assembly of the rechargeable battery according to the second embodiment of the present invention.

### MODE FOR INVENTION

Hereinafter, embodiments of the present invention will be described more fully with reference to the accompanying drawings, in which embodiments of the invention are shown. As those skilled in the art would realize, the described embodiments may be modified in various different ways. In addition, like reference numerals designate like elements throughout the specification and the drawings.

The drawings and description are to be regarded as illustrative in nature and not restrictive. Like reference numerals designate like elements throughout the specification.

In addition, since the size and thickness of each configuration shown in the drawings are arbitrarily indicated for better understanding and ease of description, the present invention is not necessarily limited to the drawings.

Throughout the specification, when it is described that an element is “connected” to another element, it includes not only a case that it is “directly connected” but also a case that it is “indirectly connected” through another member. In addition, unless explicitly described to the contrary, the word “comprise”, and variations such as “comprises” or “comprising”, will be understood to imply the inclusion of stated elements but not the exclusion of any other elements.

A rechargeable battery according to an embodiment of the present invention is an ultra-small battery, and may be a coin-type battery (coin cell) or a button-type battery (button cell). Here, the coin-type battery or button-type battery is a thin coin or button-shaped battery, and means a battery in which a ratio of height to diameter (height/diameter) is 1 or less.

Since the coin-type battery or button-type battery is mainly cylindrical, the cross-section in the horizontal direction is circular, but is not limited thereto, and a shape in which the cross-section in the horizontal direction is oval or polygonal may also be included therein. In this case, the diameter means the maximum distance with reference to the horizontal direction of the battery, and the height means the minimum distance from the flat bottom surface of the battery to the cross-section of the flat top of the battery.

However, the coin-type battery or button-type battery is not limited thereto as an example of the present invention, and the rechargeable battery according to the present invention may be a cylindrical or pin-type battery. However, hereinafter, a case in which the rechargeable battery according to an embodiment of the present invention is a coin-type battery or a button-type battery will be described in detail by way of example.

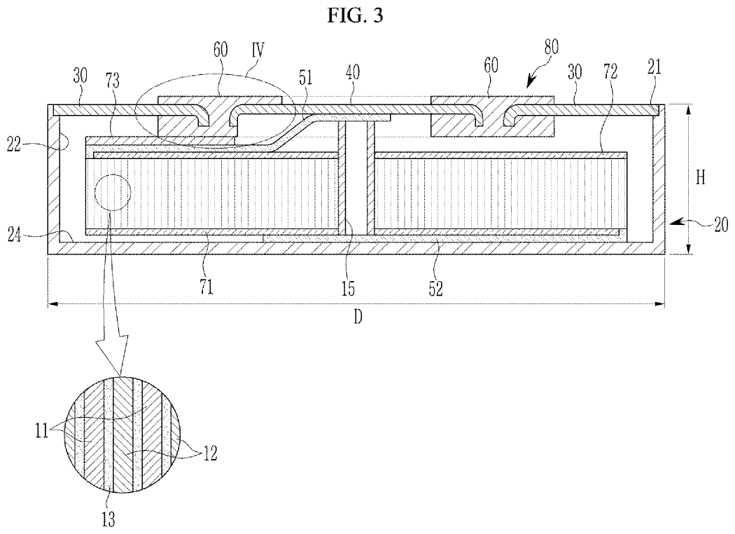

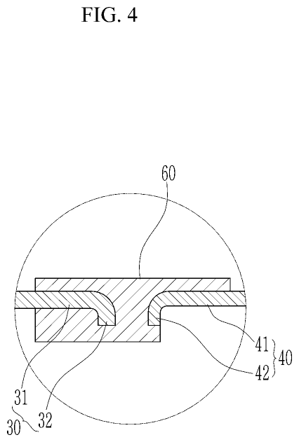

Meanwhile, in the present specification, directions such as “inside” and “inner side” mean a direction toward an electrode assembly 10, and directions such as “outside” and “outer side” mean the opposite direction. In addition, terms “upper”, “lower”, “height direction”, and “vertical direction” refer to a direction perpendicular to a bottom plate 24 (refer to FIG. 3, etc.) of a case 20 (refer to FIG. 3, etc.), and “horizontal direction” means a direction parallel to the bottom plate 24 (refer to FIG. 4, etc.).

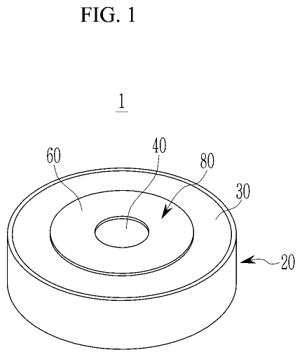

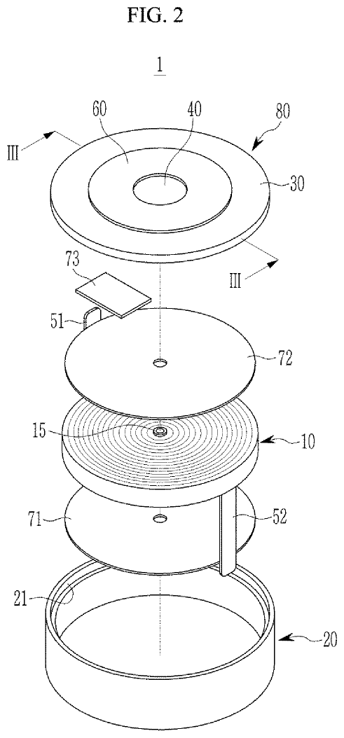

FIG. 1 is a perspective view of a rechargeable battery according to a first embodiment of the present invention, FIG. 2 is an exploded perspective view of the rechargeable battery according to the first embodiment of the present invention, and FIG. 3 is a cross-sectional view of FIG. 2, taken along the line III-III.

Referring to FIG. 1 to FIG. 3, a rechargeable battery 1 of a first embodiment of the present invention includes an electrode assembly 10, a case 20, and a cap assembly 80.

The electrode assembly 10 includes a first electrode 11 (e.g., a negative electrode) and a second electrode 12 (e.g., a positive electrode) that are provided on respective sides of a separator 13, which is an electrical insulating material, and is formed by spirally winding the first electrode 11, the separator 13, and the second electrode 12. Accordingly, the electrode assembly 10 may have a jelly-roll shape, and is formed to charge and discharge a current.

In this case, a wound axis of the electrode assembly 10 may be arranged parallel to a height direction of the case 20 (i.e., a vertical direction from a bottom surface of the case), and upper and lower surfaces of the electrode assembly 10 may be flat and parallel to each other.

The electrode assembly 10 may have a center pin 15 in place of the wound shaft. When a first electrode tab 51 and a second electrode tab 52 are respectively welded to a terminal plate 40 and the case 20 by the center pin 15, respectively, the first electrode tab 51 and the terminal plate 40 are in close contact with one end, and the second electrode tab 52 and the case 20 are in close contact with the other end to make the welding process easier. As shown in FIG. 3, the center pin 15 may be protruded in the upper direction of the electrode assembly 10 such that the first electrode tab 51 and the terminal plate 40 are into close contact.

The center pin 15 is formed as a cylinder with a hollow to enable the flow of gas and electrolyte solution inside. Alternatively, the center pin 15 may be formed of a filled cylinder (not shown).

In the following description, the first electrode 11 and the second electrode 12 will be described as a negative electrode and a positive electrode, respectively, but this is not restrictive, and the first electrode 11 and the second electrode 12 may be respectively a positive electrode and a negative electrode.

The negative electrode 11 (i.e., the first electrode) is formed of a long band shape, and includes a negative electrode coated region where an active material layer is applied to a current collector of a metal foil (e.g., a Cu foil) and a negative electrode uncoated region where the active material is not applied. The negative electrode uncoated region may be positioned at one end in a length direction of the negative electrode.

The positive electrode 12 (i.e., the second electrode) is formed of a long band shape, and includes a positive electrode coated region where an active material layer is applied to a current collector of a metal foil (e.g., an Al foil) and a positive electrode uncoated region where the active material is not applied.

The positive electrode uncoated region may be located at one end in a length direction of the positive electrode.

The first electrode tab 51 is fixedly installed to the first electrode 11, and the second electrode tab 52 is fixedly installed to the second electrode 12. The first electrode tab 51 and the second electrode tab 52 are respectively installed in the negative electrode uncoated region and the positive uncoated region, and extend to be parallel to the wound axis of the electrode assembly 10, and then the ends may be bent toward the wound axis. For example, the bent ends of the first electrode tab 51 and the second electrode tab 52 may be disposed on the upper and lower portions of the electrode assembly 10, respectively.

The first electrode tab 51 is formed of an electrically conductive material such as copper or nickel, and is electrically connected to the terminal plate 40 of the cap assembly 80. For example, the bent end of the first electrode tab 51 may be directly connected to an inner surface of the terminal plate 42 of the cap assembly 40 by welding (e.g., by laser welding).

The second electrode tab 52 is formed of an electrically conductive material such as nickel or aluminum, and is electrically connected to the cap plate 40 of the case 20 or a cap assembly 80. For example, the bent end of the second electrode tab 52 may be directly connected to an inner surface (inner bottom surface) of the case 20 by welding (e.g., laser welding).

Referring to FIG. 2 and FIG. 3, the rechargeable battery 1 according to the present embodiment may include a first insulation member 71 disposed between the second electrode tab 52 and the electrode assembly 10, and a second insulation member 72 disposed between the first electrode tab 51 and the electrode assembly 10.

For example, the first insulation member 71 and the second insulation member 72 may be disposed on a lower surface and an upper surface of the electrode assembly 10, respectively. Accordingly, the first insulation member 71 may be disposed between the lower surface of the electrode assembly 10 and the bent second electrode tab 52, and the second insulation member 72 may be disposed between the upper surface of the electrode assembly 10 and the bent first electrode tab 51.

An electrical contact between the second electrode tab 52 and the electrode assembly 10 may be prevented through the first insulation member 71, and an electrical contact between the first electrode tab 51 and the electrode assembly 10 may be prevented through the second insulation member 72.

In addition, the rechargeable battery 1 according to the present embodiment may include a third insulation member 73 disposed between the first electrode tab 51 and a cap plate 30. The cap plate 30 and the electrode plate 40 are insulated from each other by a sealing portion 60 and have different polarities, and the first electrode tab 51 is electrically connected to the electrode plate 40. Therefore, it is possible to electrically insulate between the bent first lead tab 51 and the cap plate 30 through the third insulation member 73.

Although it is not illustrated in the drawing, an outer circumferential surface of the electrode assembly 10 may be surrounded by an insulating tape. Through this, it is possible to electrically insulate between the outer circumferential surface of the electrode assembly 10 and an inner surface of the case 20, while protecting the outside of the electrode assembly 10.

The electrode assembly 10 may be inserted through an opening 21 formed on one side of the case 20 to be accommodated in the case 20. The case 20 is formed of a bottom plate 24 and a side plate 22, and a space in which the electrode assembly 10 and an electrolyte solution are accommodated is set inside the case 20. The bottom plate 24 and the side plate 22 may be integrally formed, or the bottom plate 24 and the side wall 22 may be connected by welding.

For example, the case 20 may have a cylindrical shape and may have a circular opening 21 at an upper end to insert the cylindrical electrode assembly 10. In this case, as shown in FIG. 2 and FIG. 3, an edge of the opening 21, that is, the inner surface of the upper end of the side wall 22, may have a step such that the cap assembly 80 can be supported.

The case 20 is formed of a metallic material electrically connected to the second electrode tab 52, and for example, may be formed of stainless steel, but is not limited thereto.

Referring to FIG. 1 to FIG. 3, the cap assembly 80 closes and seals the opening 21 of the case 20, and can be welded to the opening 21. The cap assembly 80 includes a cap plate 30, a terminal plate 40, and a sealing portion 60.

In the cap assembly 80, the cap plate 30 and the terminal plate 40, which are metallic materials, and the sealing portion 60, which is an insulating material, may be integrally formed through an insert molding method. Accordingly, durability of the cap assembly 80 can be improved, and the cap assembly 80 can be formed in the form of a thin disk. Accordingly, the battery capacity may be increased.

Exemplarily, the cap plate 30 and the terminal plate 40 may be formed of stainless steel, but is not limited thereto, and may be formed of various metallic materials having electrical conductivity. In addition, the sealing portion may be formed of a resin material having electrical insulation.

Hereinafter, a configuration of the cap assembly 80 in the rechargeable battery 1 according to the first embodiment of the present invention will be described in detail.

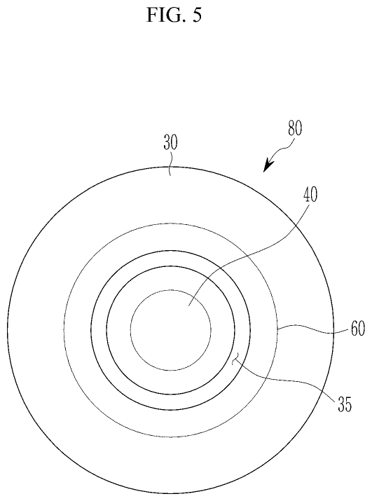

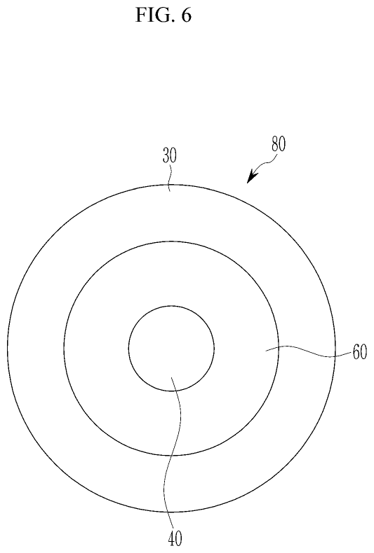

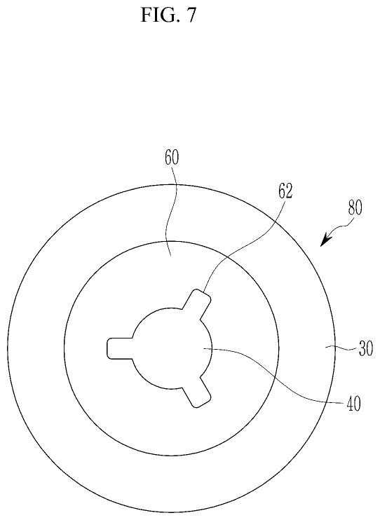

FIG. 4 is an enlarged view of the portion IV of FIG. 3, and FIG. 5 to FIG. 7 show the cap assembly of the rechargeable battery according to the first embodiment of the present invention. For better comprehension, FIG. 5 shows the cap assembly 80, excluding the sealing portion 60 in a top plan view, and FIG. 6 and FIG. 7 show the appearance of the cap assembly 80 including the sealing portion 60 in a top view and a bottom view, respectively.

Referring to FIG. 3 to FIG. 7, the cap assembly 80 is in the form of a thin disk as a whole, and the cap plate 30, the terminal plate 40, and the sealing portion 60 may be concentrically disposed.

The cap plate 30 may be formed as an annular plate with a terminal hole 35 in the center. The terminal hole 35 may be circular, and an outer circumferential portion of the cap plate 30 may be coupled to the opening 21 of the case 20.

The cap plate 30 may be welded to the case 20 and has the same polarity as the case 20. For example, the cap plate 30 may have the same polarity as the second electrode 12 electrically connected to the case 20.

The terminal plate 40 is disposed in the terminal hole 35 and has a polarity that is different from that of the cap plate 30. That is, the terminal plate 40 is electrically connected with the first electrode 11. Accordingly, the terminal plate 40 may be spaced apart from a circumferential portion (hereinafter, an inner circumferential portion) of the terminal hole 35 side of the cap plate 30, and the sealing portion 60 formed of an insulating material may be disposed between the inner circumferential portion of the cap plate 30 and the terminal plate 40.

A thickness of terminal plate 40 may be less than a thickness of the cap plate 30. The first electrode tab 51 may be connected to the inner surface of the terminal plate 40 by laser welding, and laser welding between the inner surface of the terminal plate 40 and the first electrode tab 51 can be facilitated from the outside by reducing the thickness of the terminal plate 40.

One side (e.g., top) of the cap plate 30 and one side (e.g., top) of the terminal plate 40 may be arranged on the same plane. In this case, between the cap plate 30 and the terminal plate 40 is connected to by the sealing portion 60, and the upper surface and the bottom surface of the sealing portion 60 may be formed in a flat shape. Accordingly, the cap plate 30, the sealing portion 60, and the terminal plate 40 may be formed in a thin plate shape as a whole.

The sealing portion 60 seals between the cap plate 30 and the terminal plate 40. The sealing part 60 may cover an inner circumferential portion of the cap plate 30 and a circumferential portion of the terminal plate 40. For example, referring to FIG. 3 and FIG. 4, the cap plate 30 and the terminal plate 40 may be disposed between the top and bottom surfaces of the sealing portion 60.

Referring to FIG. 3 to FIG. 7, the sealing portion 60 may have an annular shape, and the inner circumferential portion of the cap plate 30 and the circumferential portion of the terminal plate 40 may have structures inserted into the outer circumferential portion and the inner circumferential of the sealing portion 60, respectively.

As previously described, the cap plate 30 formed of a metallic material, the terminal plate 40 and the sealing portion 60 formed of a resin material may be integrally formed through an insert injection method. As the cap plate 30, the terminal plate 40 and the sealing portion 60 are coupled by the insert injection method, and structures in which the inner circumferential portion of the cap plate 30 and the circumferential portion of the terminal plate 40 are inserted into the outer circumferential portion and the inner circumferential portion of the sealing portion 60 can be formed, respectively. In addition, it is possible to increase the bonding force and sealing force between the cap plate 30, the terminal plate 40, and the sealing portion 60, which are formed of heterogeneous materials.

According to the present embodiment, at least one of an end of the inner circumferential portion of the cap plate 30 covered by the sealing portion 60 and an end of the circumferential portion of the terminal plate 40 may be curved. For example, as shown in FIG. 3 and FIG. 4, the cap plate 30 may include a flat portion 31 extending in a horizontal direction and a bending portion 32 bent in a vertical direction from an end of the flat portion 31.

In addition, the terminal plate 40 may include a flat portion 41 extending in a horizontal direction, and a bending portion 42 bent in a vertical direction at an end of the flat portion 41. Accordingly, the bonding force and sealing force between the cap plate 30, the terminal plate 40, and the sealing portion 60 can be further increased.

Meanwhile, referring to FIG. 7, a plurality of exposed grooves 62 extending in a radial direction from an inner circumferential portion of the sealing portion 60 may be provided on a bottom surface of the sealing portion 60. The plurality of exposed grooves 62 are portions in which the sealing portion 60 is not formed by a jig for fixing the terminal plate 40 to the center during the insert injection process. Accordingly, a portion of the circumferential portion of the terminal plate 40 may be exposed from the sealing portion 60 through the plurality of exposed grooves 62.

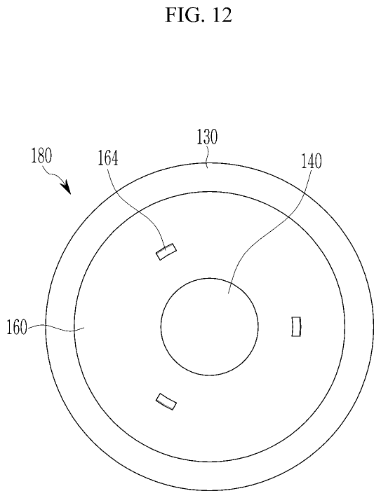

Meanwhile, the portion where the sealing portion is not formed by the jig for fixing the terminal plate in the insert injection process may be formed in the shape of a hole (refer to FIG. 12).

Hereinafter, a second embodiment of the present invention will be described. Compared with the above-described first embodiment, a description of the same components will be omitted and different configurations will be described.

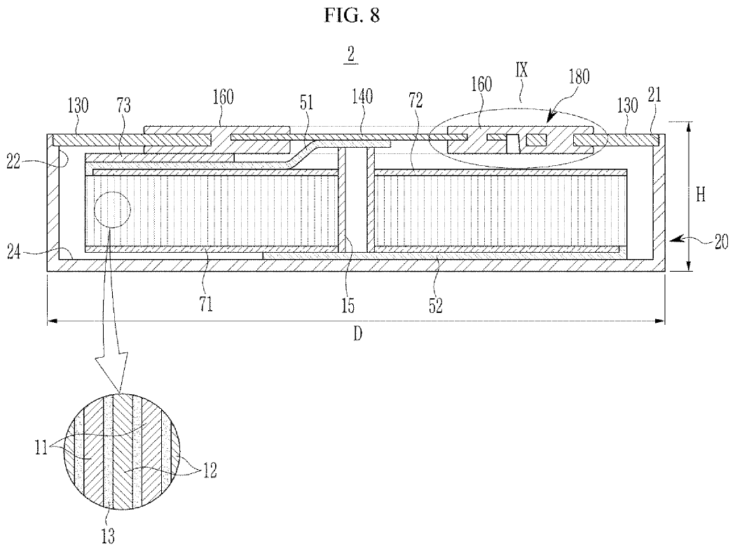

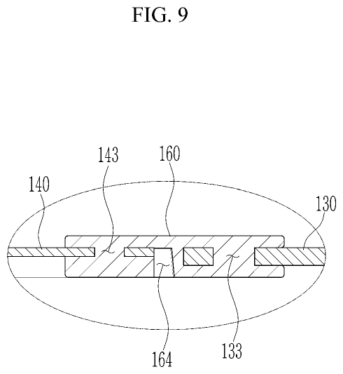

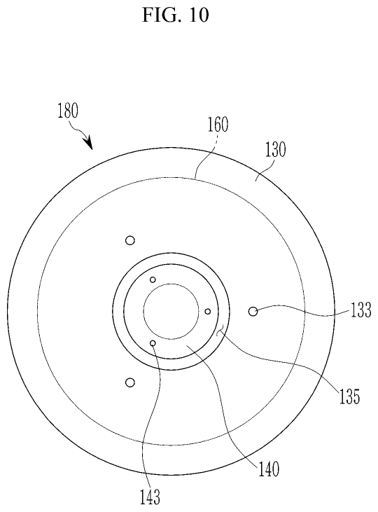

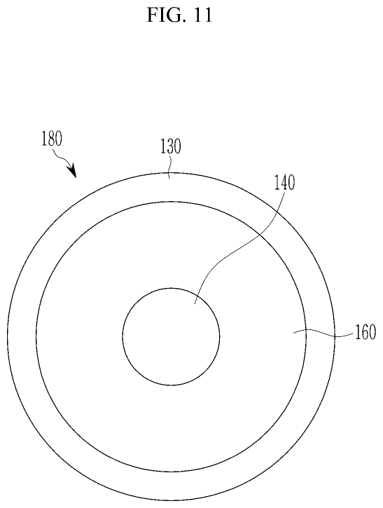

FIG. 8 is a cross-sectional view of a rechargeable battery according to a second embodiment of the present invention, FIG. 9 is an enlarged view of the portion IX of FIG. 8, and FIG. 10 to FIG. 12 show a cap assembly of the rechargeable battery according to the second embodiment of the present invention. For better comprehension, FIG. 10 shows the cap assembly 80, excluding the sealing portion 60 in a top plan view, and FIG. 11 and FIG. 12 show the appearance of the cap assembly 80 including the sealing portion 60 in a top view and a bottom view, respectively.

Referring to FIG. 8, a rechargeable battery 2 according to the second embodiment of the present invention is the same as the above-described rechargeable battery 1 of the first embodiment except for a cap assembly 180.

According to the present embodiment, at least one of an inner circumferential portion of a cap plate 130 covered by a sealing portion 160 and a circumferential portion of a terminal plate 140 may be provided with a plurality of penetration holes. For example, as shown in FIG. 8 to FIG. 10, a plurality of first penetration holes 133 may be formed in an inner circumferential portion of the cap plate 30 covered by the sealing portion 160, and the sealing portion 160 may be inserted into the plurality of first penetration holes 133. In addition, a plurality of second penetration holes 143 may be formed in an circumferential portion of the terminal plate 40 covered by the sealing portion 160, and the sealing portion 160 may be inserted into the plurality of second penetration holes 143.

Accordingly, the bonding force and sealing force between the cap plate 30, the terminal plate 40, and the sealing part 60 may be further increased.

In addition, the plurality of first penetration holes 133 and the plurality of second penetration holes 143 may be spaced apart at a predetermined angle and may be radially arranged. Accordingly, the cap assembly 180 may have a uniform bonding force in the radial direction.

In FIG. 10, three first penetration holes 133 and three second penetration holes 143 are radially arranged to the inner circumferential portion of the cap plate 30 and the circumferential portion of the terminal plate 40, respectively, but the present invention is not limited thereto, and the second penetration holes 143 can be disposed in various shapes.

In comparison with the cap assembly 80 in the rechargeable battery 1 of the first embodiment described above, the cap assembly 180 in the rechargeable battery 2 of the second embodiment has the plurality of penetration holes 133 and 143 instead of the bent portions 32 and 42 (refer to FIG. 4, etc.) to increase the bonding and sealing force. Therefore, it is possible to form a thinner cap assembly than the first embodiment, thereby increasing the battery capacity.

Meanwhile, referring to FIG. 12, the bottom surface of the sealing portion 160 may be provided with a plurality of exposed holes 164 disposed at predetermined angle intervals along the circumferential direction. The plurality of exposed holes 164 are portions where the sealing portion 160 is not formed by a jig for fixing the terminal plate 140 to the center during an insert injection process. Accordingly, a part of the circumferential portion of the terminal plate 140 may be exposed from the sealing portion 160 through the plurality of exposure holes 164.

Meanwhile, even in the second embodiment, the portion where the sealing portion is not formed by the jig for fixing the terminal plate during the insert injection process may be formed in the form of a groove extending in the radial direction from the inner circumferential portion of the sealing portion (refer to FIG. 7).

The rechargeable batteries 1 and 2 according to the above-described embodiments of the present invention may be coin-type batteries or button-type batteries, and a height H (refer to FIG. 3) with respect to a diameter D (refer to FIG. 3 and FIG. 8) may have a ratio (H/D) of 1 or less.

As such, in the rechargeable batteries 1 and 2 according to the embodiments of the present invention, the sealing portions 60 and 160 are disposed in the terminal holes 35 and 135 of the cap plates 30 and 130 to install the terminal plates 40 and 140, and thus the cap assemblies 80 and 180 can be formed in the shape of a plate having a thin thickness. In this case, the cap plates 30 and 130, the sealing portions 60 and 160, and the terminal plates 40 and 140 may be integrally formed by the insert injection method. Accordingly, it is possible to increase the battery capacity by reducing the thickness of the cap assemblies 80 and 180 of the rechargeable batteries 1 and 2, and it is possible to improve the durability of the cap assemblies 80 and 180. In addition, welding work between the first electrode tab 51 of the electrode assembly 10 and the terminal plates 40 and 140 may be facilitated.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

1, 2 rechargeable battery 10 electrode assembly
11 first electrode (negative electrode)
12 second electrode (positive electrode)
12 separator 15 center pin
20 case 21 opening
30, 130 cap plate 35, 135 terminal hole
40, 140 terminal plate
51 first electrode tab (negative electrode tab)
52 second electrode tab (positive electrode tab)
60, 160 sealing portion
71 first insulation member 72 second insulation member
73 third insulation member 133 first penetration hole
143 second penetration hole 80, 180 cap assembly

1. A rechargeable battery comprising:
an electrode assembly in which a separator is disposed between a first electrode and a second electrode;
a case including an opening at one side, and accommodating the electrode assembly; and
a cap assembly that is coupled to the opening to close and seal the case,
wherein the cap assembly comprises:
a cap plate coupled to the opening and having a terminal hole;
a terminal plate disposed in the terminal hole; and
a sealing portion that is formed of an insulating material, and seals between the cap plate and the terminal plate by covering a circumferential portion of the terminal hole side of the cap plate and a circumferential portion of the terminal plate.

2. The rechargeable battery of claim 1, wherein
the cap plate, the terminal plate, and the sealing portion are integrally formed by insert injection.

3. The rechargeable battery of claim 1, wherein
one side of the cap plate and one side of the terminal plate are arranged on the same plane.

4. The rechargeable battery of claim 1, wherein
a top surface and a bottom surface of the sealing portion are flat, and the cap plate and the terminal plate are disposed between the top and bottom surfaces of the sealing portion.

5. The rechargeable battery of claim 1, wherein
the sealing portion is annular, and
a circumferential portion of the terminal hole side of the cap plate and a circumferential portion of the terminal plate are respectively inserted into an outer circumferential portion and an inner circumferential portion of the sealing portion.

6. The rechargeable battery of claim 1, wherein
a thickness of the terminal plate is smaller than a thickness of the cap plate.

7. The rechargeable battery of claim 1, further comprising:
a first electrode tab that electrically connects the first electrode to the terminal plate; and
a second electrode tab that electrically connects the second electrode to the case and the cap plate.

8. The rechargeable battery of claim 7, wherein
in the electrode assembly, the first electrode, the second electrode, and the separator are wound around a center pin, and the center pin is arranged in a vertical direction on a bottom surface of the case.

9. The rechargeable battery of claim 8, wherein
the first electrode tab is extended upwardly of the electrode assembly and welded to an inner surface of the terminal plate, and
the second electrode tab extends downwardly of the electrode assembly and welded to an inner surface of the case.

10. The rechargeable battery of claim 9, further comprising:
a first insulation member that is disposed between the first electrode tab and a top surface of the electrode assembly; and
a second insulation member that is disposed between the second electrode tab and a bottom surface of the electrode assembly.

11. The rechargeable battery of claim 10, further comprising
a third insulation member that is disposed between the first electrode tab and the cap plate.

12. The rechargeable battery of claim 1, wherein at least one of an end of the circumferential portion of the terminal hole side of the cap plate and an end of the circumferential portion of the terminal plate is bent.

13. The rechargeable battery of claim 12, wherein
the end of the circumferential portion of the terminal hole side of the cap plate and the end of the circumferential portion of the terminal plate are provided with bending portions that are bent in a direction perpendicular to an extension direction of the terminal plate.

14. The rechargeable battery of claim 1, wherein
a plurality of penetration holes are formed in at least one of the circumferential portion of the terminal hole side of the cap plate and the circumferential portion of the terminal plate.

15. The rechargeable battery of claim 14, wherein
the sealing portion is inserted into the plurality of penetration holes.

16. The rechargeable battery of claim 5, wherein
a plurality of exposed grooves extending in a radiation direction in an inner circumferential portion of the sealing portion are formed on a bottom surface of the sealing portion.

17. The rechargeable battery of claim 5, wherein
a plurality of exposed holes disposed at predetermined angle intervals along a circumferential direction are formed on a bottom surface of the sealing portion.

18. The rechargeable battery of claim 1, wherein
the case is cylindrical, and the cap plate is welded to the opening of the case.

19. A rechargeable battery of claim 1, wherein
the rechargeable battery has a height-to-diameter ratio of 1 or less.
